(19) United States
(12) Patent Application Publication
(10) Pub. No.: US 2011/0132113 A1
(43) Pub. Date: Jun. 9, 2011

(54) TRANSMISSION MECHANISM

(75) Inventor: SHANG-XUAN SONG, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Taipei Hsien (TW)

(21) Appl. No.: 12/712,421

(22) Filed: Feb. 25, 2010

(30) Foreign Application Priority Data
Dec. 9, 2009 (CN) 200910311117.0

(51) Int. Cl. F16H 35/18

(52) U.S. Cl. 74/10.85

(57) ABSTRACT

A transmission mechanism includes a threaded fastener and a nut assembly. The nut assembly is sleeved on the threaded fastener, and includes a first nut, a second nut, and an elastic member. The first nut forms two receiving portions, and the second nut defines two receiving cutouts. The elastic member is positioned between the first nut and the second nut. The receiving portions are received in the receiving cutouts, such that the first nut and second nut move only along an axis of the threaded fastener. The elastic member is compressed by the first nut and the second nut, to generate an elastic force exceeding a component force along the axis of the threaded fastener of an external force for rotating the first nut or the second nut.

### BACKGROUND

1. Technical Field

The present disclosure relates generally to transmission mechanisms and, more particularly, to a transmission mechanism using a threaded fastener.

2. Description of Related Art

A transmission mechanism including a threaded fastener received in a nut is widely used in modern industry. However, a gap is frequently formed between the threaded fastener and the nut due to abrasion therebetween or assembly error. Therefore, a real distance of the nut moving relative to the threaded fastener is different from a predetermined moving distance of the nut due to the gap between the nut and the threaded fastener, that is, a movement error is caused.

A typical transmission mechanism to alleviate the movement error includes a threaded fastener, a first nut, a second nut, an elastic member and a connecting plate. The first nut and the second nut are common nuts, and threaded onto the threaded fastener. The elastic member is sleeved on the threaded fastener, and compressed between the first nut and the second nut. The connecting plate is adjacent to the second nut, and connected to the first nut via a plurality of fasteners. During assembly of the typical transmission mechanism, the fasteners can be adjusted such that the first nut and the second nut receive the threaded fastener with no gap, alleviating the movement error.

However, over time wear and tear on the parts can result in movement error as before. In addition, it is time-consuming to assemble the typical transmission mechanism because the fasteners need to be adjusted.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an embodiment of a transmission mechanism.

FIG. 2 is an exploded, isometric view of the transmission mechanism of FIG. 1.

FIG. 4 is a cross-section of the transmission mechanism of FIG. 1, taken along the line III-III.

FIG. 4 is an enlarged view of a circular portion IV of FIG. 3.

FIG. 5 is an enlarged view of a circular portion V of FIG. 3.

### DETAILED DESCRIPTION

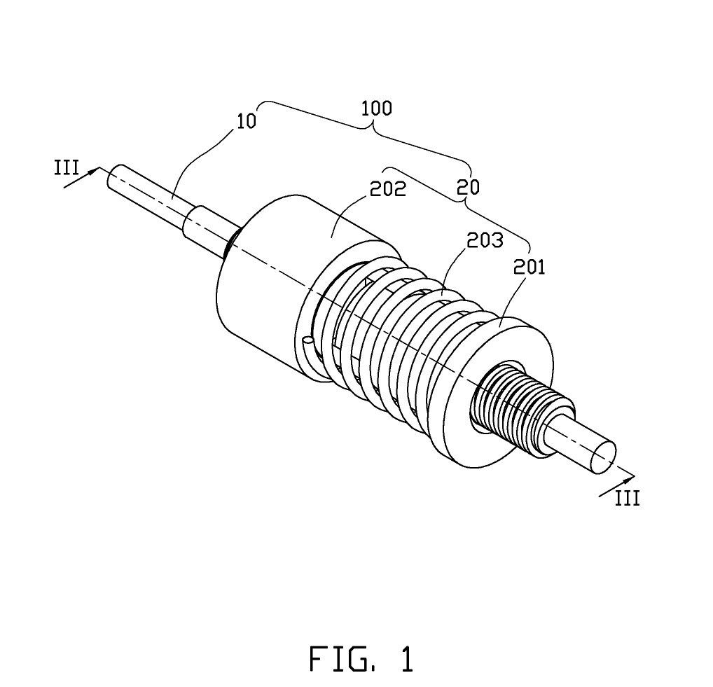

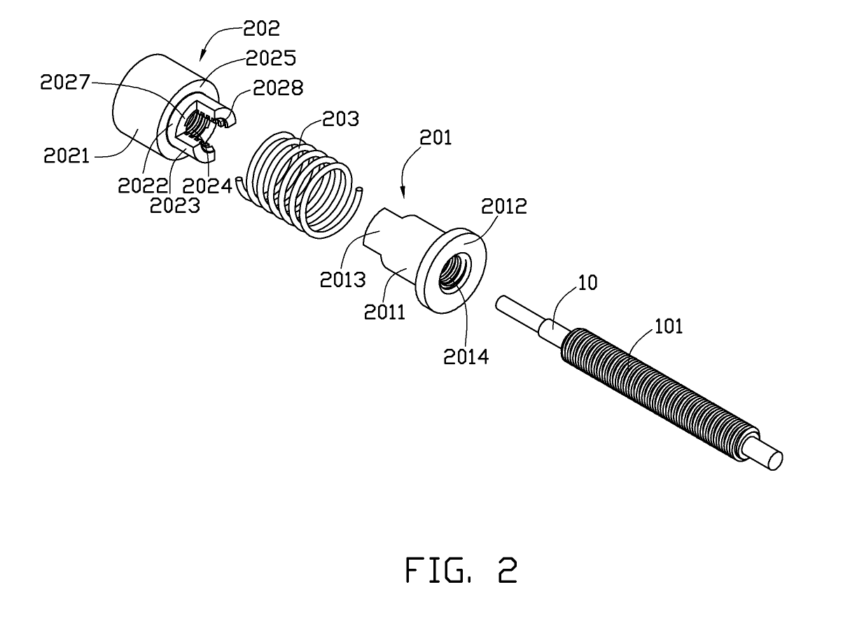

Referring to FIGS. 1 through 3, an embodiment of a transmission mechanism 100 includes a threaded fastener 10 and a nut assembly 20 threaded thereon. The threaded fastener 10 defines a plurality of threads 101. The nut assembly 20 includes a first nut 201, a second nut 202, and an elastic member 203. One end of the elastic member 203 is sleeved on the first nut 201, and the other end of the elastic member 203 is sleeved on the second nut 202.

The first nut 201 includes a first main body 2011, a resisting portion 2012, and two first receiving portions 2013. The first main body 2011 is substantially cylindrical. The resisting portion 2012 and the first receiving portions 2013 extend from opposite sides of the first main body 2011. A diameter of the resisting portion 2012 exceeds that of the first main body 2011. The resisting portion 2012 has a resisting surface 2015. The first nut 201 axially defines a first threaded hole 2014. In the illustrated embodiment, the first receiving portions 2013 are curved protrusions opposite to each other. Each receiving portion 2013 has a threaded inner surface (not shown).

The second nut 202 includes a second main body 2021, a flange portion 2022, and two second receiving portions 2023. The second main body 2021 is substantially cylindrical, and axially defines a second threaded hole 2024. The flange portion 2022 is an annular portion extending from an end of the second main body 2021. The second main body 2021 has a resisting surface 2045 around the flange portion 2022. The second receiving portions 2023 are formed on the flange portion 2022 opposite to each other. The second receiving portions 2023 and the flange portion 2022 cooperatively define two receiving cutouts 2027. In the illustrated embodiment, the second receiving portions 2023 are curved protrusions. Each receiving portion 2023 has a threaded inner surface 2028.

The elastic member 203 may be a compression spring.

During assembly of the transmission mechanism 100, the first nut 201, the second nut 202, and the elastic member 203 are sleeved on the threaded fastener 10. The elastic member 203 is positioned between the first nut 201 and the second nut 202. The first receiving portions 2013 of the first nut 201 are received in the receiving cutouts 2027 of the second nut 202. The first nut 201 and the second nut 202 can be adjusted to decrease a distance between the resisting portion 2012 of the first nut 201 and the flange portion 2022 of the second nut 202. The elastic member 203 is compressed accordingly, until the elastic force generated thereby exceeds the component force along the axis of the threaded fastener 10 of an external force rotating the first nut 201 or the second nut 202.

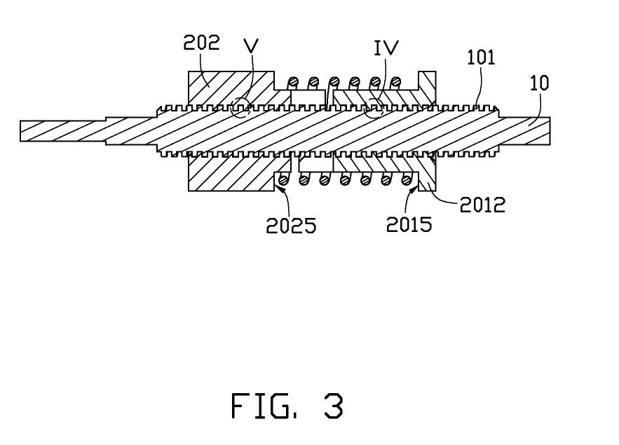

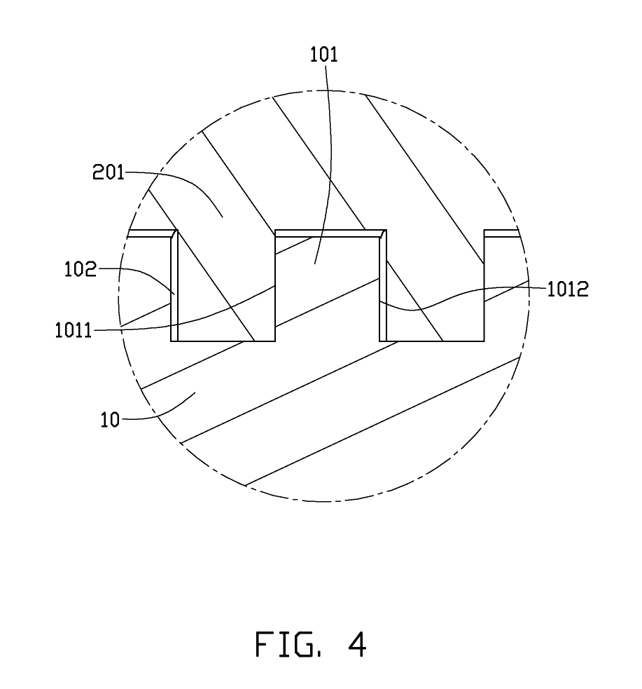

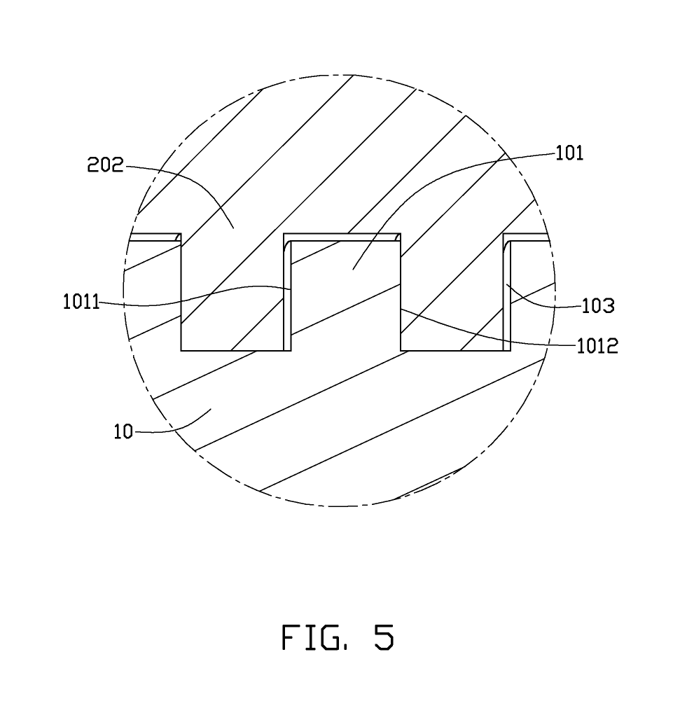

Referring to FIGS. 4 and 5, in use, when the first nut 201 and the second nut 202 are rotated relative to the threaded fastener 10, the first nut 201 and the second nut 202 cannot rotate relative to each other because the first receiving portions 2013 are received in the receiving cutouts 2027 of the second nut 202. After the first nut 201 and the second nut 202 bias, a first gap 102 is generated between the first nut 201 and the threaded fastener 10, and a second gap 103 is generated between the second nut 202 and the threaded fastener 10. The first nut 201 is moved by the elastic member 203 until the first nut 201 resists a first side surface 1011 of each threaded fastener thread 101 of the threaded fastener 10, and the second nut 202 is moved by the elastic member 203 until the second nut 202 resists a second side surface 1012 of each thread 101 opposite to the first side surface 1011.

Since the elastic force generated by the elastic member 203 exceeds the component force along the axis of the threaded fastener 10 of an external force when rotating the first nut 201 or the second nut 202, the first nut 201 can resist the first side surface 1011 of each threaded fastener thread 101 as the first nut 201 rotates on the threaded fastener 10, and the second nut 202 can resist the second side surface 1012 of each threaded fastener thread 101 as the first nut 201 rotates on the threaded fastener 10. Therefore, the first nut 201 and the second nut 202 continuously resists the threaded fastener threads 101 in a rotating process of the first nut 201 and the second nut 202. That is, the first nut 201 and the second nut 202 cannot stay at different positions between the threaded fastener threads 101 of the threaded fastener 10. Accordingly, movement error of the first nut 201 and the second nut 202 is eliminated. In addition, each first receiving portion 2013 has a threaded inner surface, and each second receiving portion 2023 has a threaded inner surface 2028, such that a threaded area of the nut assembly 20 and the threaded fastener 10 increases, and the nut assembly 20 can move more stably on the threaded fastener 10.

It should be pointed out that the first nut 201 may form one first receiving portion 2013 or more than two first receiving portions 2013, and correspondingly, the second nut 202 defines one receiving cutout 2027 or more than two receiving cutouts 2027.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A transmission mechanism, comprising:
a threaded fastener; and
a nut assembly sleeved on the threaded fastener, the nut assembly comprising:
a first nut forming at least one first receiving portion;
a second nut defining at least one receiving cutout; and
an elastic member positioned between the first nut and the second nut;
wherein the at least one first receiving portion is received in the at least one receiving cutout, such that the first nut and second nut move only along an axis of the threaded fastener, wherein the elastic member is compressed by the first nut and the second nut to generate an elastic force exceeding a component force along the axis of the threaded fastener of an external force rotating the first nut or the second nut.

2. The transmission mechanism of claim 1, wherein the first nut further comprises a first main body and a resisting portion, the resisting portion and the at least one first receiving portion extending from opposite sides of the first main body.

3. The transmission mechanism of claim 2, wherein the first main body axially defines a first threaded hole receiving the threaded fastener.

4. The transmission mechanism of claim 2, wherein the resisting portion comprises a resisting surface, which resists the elastic member.

5. The transmission mechanism of claim 1, wherein the first nut comprises two opposite first receiving portions.

6. The transmission mechanism of claim 1, wherein the second nut further comprises a second main body and an annular flange portion extending from an end of the second main body.

7. The transmission mechanism of claim 6, wherein at least one second receiving portion is formed on the flange portion, and the at least one second receiving portion and the flange portion cooperatively define the at least one receiving cutout.

8. The transmission mechanism of claim 6, wherein the second main body axially defines a second threaded hole receiving the threaded fastener.

9. The transmission mechanism of claim 6, wherein the at least one second receiving portion comprises a threaded inner surface.

10. The transmission mechanism of claim 6, wherein the flange portion comprises a resisting surface resisting the elastic member.

11. The transmission mechanism of claim 1, wherein the threaded fastener forms a plurality of threaded fastener threads engaging with the first nut and the second nut.

12. The transmission mechanism of claim 1, wherein the elastic member is a compression spring.

13. A transmission mechanism, comprising:
a threaded fastener defining a plurality of threaded fastener threads; and
a nut assembly sleeved on the threaded fastener, the nut assembly comprising:
a first nut;
a second nut; and
an elastic member positioned between the first nut and the second nut;
wherein the first nut is non-rotatably connected to the second nut, the elastic member is compressed by the first nut and the second nut, thereby generating an elastic force to enable the first nut and the second nut to continuously resist the threaded fastener threads of the threaded fastener.

14. The transmission mechanism of claim 13, wherein the first nut comprises a first main body, at least one first receiving portion, and a resisting portion, the resisting portion and the at least one first receiving portion extending from opposite sides of the first main body.

15. The transmission mechanism of claim 14, wherein the first main body axially defines a first threaded hole in which the threaded fastener is received.

16. The transmission mechanism of claim 13, wherein the second nut further comprises a second main body and an annular flange portion extending from an end of the second main body.

17. The transmission mechanism of claim 16, wherein at least one second receiving portion is formed on the flange portion, cooperatively forming the at least one receiving cutout with the at least one second receiving portion.

18. The transmission mechanism of claim 16, wherein the at least one second receiving portion comprises a threaded inner surface.

19. The transmission mechanism of claim 13, wherein the first nut and the second nut are threaded on the threaded fastener threads.

20. The transmission mechanism of claim 13, wherein the elastic member is a compression spring.
